(19) United States
(12) Patent Application Publication
(10) Pub. No.: US 2026/0295466 A1
(43) Pub. Date: Oct. 1, 2026

(54) COALESCING PLATE STACK SUPPORTS

(71) Applicant: PARK ENVIRONMENTAL EQUIPMENT, LLC, Houston, TX (US)

(72) Inventors: Christopher Nolan EBERLY, Chappell Hill, TX (US); Andreas H. VU, Houston, TX (US); Kate T. VU, Houston, TX (US)

(21) Appl. No.: 19/089,732

(22) Filed: Mar. 25, 2025

(51) Int. Cl. B01D 17/04; B01D 17/00

(52) U.S. Cl. CPC B01D 17/045; B01D 17/10; B01D 2201/0415

(57) ABSTRACT

A coalescing system for separating immiscible components from of different densities mixed in the fluid has a vessel with a fluid inlet and a lighter component outlet and a heavier component outlet, a coalescing stack formed of a plurality of vertically spaced-apart coalescing plates, at least a pair of bottom supports each having a bottom surface and having an undulating upper surface conforming to corrugations of a lowermost coalescing plate of the coalescing stack, and at least a pair of top supports having an undulating bottom surface conforming to corrugations of an upper coalescing plate of the coalescing stack. Each of the bottom supports and the top supports has an identical configuration which are inverted with respect to each other relative to the coalescing stack.

### CROSS-REFERENCE TO RELATED APPLICATIONS

Not applicable.

### FIELD OF THE INVENTION

The present invention relates to the field of separation of oil, solid particles and water for environmental and industrial purposes. More particularly, the present invention relates to coalescing stacks used for the separation of oil and solid particles from water.

### BACKGROUND OF THE INVENTION

There is a need for economical oil/water separators to process rainwater and industrial wastewater so as to remove hydrocarbons and vegetable oils. These oil/water separators can also remove incidentally included oil from machine-tool coolant. Coalescing media is often used as part of the oil/water separators. Coalescing media consists of stacked plates composed generally of plastic and other materials. The stacked plates may be flat, corrugated or angled in multiple corrugated plates or in a coalescing plate stack. Coalescing media can be stacked either horizontally or at an angle from horizontal. The coalescing media as part of the separator which actually capture small oil droplets in order to remove them from flowing downstream, and directs the captured oil to the upper surface of the water. Typically, the oil is captured on the underside of the plates according to Stokes' law by the oil droplets rising up to meet the underside of the plates and forming a film thereon and eventually migrating up to the underside of the plates to the oil ports in the peaks of the plates.

An example of a coalescing plate packing system of the prior art was shown in U.S. Pat. No. 5,068,035, issued on Nov. 26, 1991 to K. S. Mohr. This coalescing plate packing system is illustrated, in particular, in association with the prior art of FIGS. 1 and 2. FIGS. 1 and 2 show a system for separating immiscible heavier and lighter components of a fluid mixture. The system includes a vessel 10 having a bottom 12, and an open top 14. It also includes end walls 16 and 18 that are in parallel planar relationship to each other. There also parallel planar side walls 20 and 22 (see FIG. 2). The vessel 10 includes a mixture inlet 24, a lighter component outlet 26 and a heavier component outlet 28. A weir 30 provides a means of skimming off lighter components, such as oil.

The system 10 has the lighter oil component accumulated on the top of the mixture and flows over the top edge 30A of weir 30 into the lighter component outlet 26. In contrast, water 34 accumulates in the lower portion of the vessel. The interface between the lighter component, oil and the heavier component (water) is indicated at 36. A means is provided for maintaining interface 36 at a preselected level below the top edge 30A of weir 30. A float 38 senses the level of interface 36 and, by means of a control system, water 38 is drained from the vessel through a pneumatic line 44 through a control valve 46. This maintains the interface level 36.

In order to enhance the separation of lighter components from heavier components of a mixture, a coalescing pack 48 is provided. The coalescing pack is assembled as a unit outside of the vessel 10 and placed as a unit into the vessel. The coalescing pack 48 includes a plurality of coalescing plates 50, a pair of bottom supports 52 and 58 that stand upright in spaced parallel planes, and a pair of top supports 56 and 58 that are placed in vertical planes above the bottom supports 52 and 54, respectively.

Each of the coalescing plates 50 has orthogonally structured corrugations, running both laterally and longitudinally along a single plane of the plate. This arrangement provides the plates with crests and valleys. Opening 60 are provided in the valleys and presses. Semi-circular opening 62 are provided in the edges. The semi-circular opening 62 opens in the crest of the lateral corrugations when plates are joined contiguous to each other. The opening 60 formed in the lateral valleys of the corrugated plates 50 permit the heavier liquid component (i.e. water) and particulate matter to migrate through the plates in vertical downward migration. Opening 60 in the crests permit the lighter component (i.e. oil) to migrate vertically upwardly.

FIG. 2 shows details, in an elevation view, of a bottom support 52 and a top support 56. The supports are preferably mold of a polymeric material. The supports 52 and 56 are used in an upright arrangement and spaced apart in generally parallel planes. The bottom support 52 has a bottom edge 64 that is preferably flat or at least of a configuration to substantially conform to the bottom 12 of the vessel 10.

Bottom support 52 further has an upper edge 66 that corresponds to the lateral core occasions of the coalescing plates 50. The perimeter of bottom support 50 is completed by opposite parallel sides 68 and 70. The spacing between the sides 68 and 70 is slightly less than the spacing between the vessel side walls 20 and 22. Bottom support 52 is preferably of a molded polymeric material and has integral reinforcing rib 72 that can be arranged in a variety of different configurations to add strength to the structure. The bottom support 52 is closed such that fluid cannot flow through it since there are no openings between the ribs.

The top support 56 is preferably molded of a polymeric material and has a top edge 74 that is generally flat. A bottom edge is undulating to conform to the lateral corrugation of coalescing plates 50. Top support 56 further has opposed sides 78 and 80 that are parallel to each other and spaced apart by a width that is slightly less than the width of the vessel side walls 20 and 22.

Bottom support 52 has a small diameter vertical passageway 82 therein that is centrally located between sides 68 and 70. The top support 56 has a vertical passageway 84 equally spaced between sides 78 and 80. The passageways 82 and 84 are in vertical alignment with each other. Openings 82 and 84 receive an elongated rod 86 that has a threaded portion adjacent each other. Rod 86 is used for each of the pair of top and bottom supports. Nuts 88 and 90 are used to secure the stack of coalescing plates 50 between the opposing pairs of bottom supports 52 and 54 and the top supports 56 and 58 in a unitary package. Thus, the coalescing package 48 can be assembled and installed into the vessel. Each of the top supports 56 and 58 can have an integral lifting eye 92 and 94.

The top supports 56 and 58 each has semi-circular recesses at the opposed sides 78 and 80. Recesses 96 coincide in alignment with the semi-circular opening 62 of the coalescing plates. The recess 96 in the top and bottom supports and the semi-circular opening 62 in the coalescing plates receive tubes 98. Tubes 98 may be inserted into the aligned semi-circular openings in the top and bottom coalescing supports after the pack 48 is inserted into the vessel 10.

The support legs of FIGS. 1 and 2 require plastic injection molding with two separate tools and a complex two-axis actuation. As such, the system of FIGS. 1 and 2 utilizes excess material. The use of this two-axis actuation in the manufacturing process increases production time and increases costs. This requirement during the manufacture of these top and bottom supports has adds complexity and requires unnecessary equipment.

In the past, a variety of patents and publications have issued with respect to such coalescing plate packs and the supports associated therewith. An early patent is that of U.S. Pat. No. 3,847,813, issued on Nov. 12, 1974 to J. L. Castelli. This patent describes a coalescing plate for a fluid mixture plate separator. These coalescing plates are formed with integral spacers so as to permit the plates to be joined in the stacks. The stacks can be made with the plates vertically aligned or offset laterally for inclined stacks.

U.S. Pat. No. 4,802,978, issued on Feb. 7, 1989 to Schmit et al., teaches an oil/water separator that having a vertical, cylindrical tank with a plurality of corrugated, oleophilic plates. A corrugated diffusion baffle is located adjacent an oil/water mixture inlet to remove the larger particulate material from the mixture and cause coalescing of the larger oil droplets. The flow of the oil/water mixture proceeds generally in a vertical direction and passes between the corrugated plates to cause further coalescing of the oil droplets. A separate oil channel directs the coalesced oil to an upper portion of the tank. The clarified water then passes downwardly to a clean water outlet.

U.S. Pat. No. 5,762,810, issued on Jun. 9, 1988 to Pelton et al. discloses a coalescing oil/water separator for removing free and dispersed oil from a wastewater stream with increased separation efficiency so as to produce a substantially oil-free effluent. The coalescing oil/water separator is self-contained in a tank shell and includes an improved oil coalescing medium for separating oil out of the wastewater and a series of baffles and weirs to direct flow, to skim the separated oil, and to control the liquid level in the separator. The oil coalescing medium includes a plurality of molded, stackable perforated sheets or plates having an oleophilic surface and an increased coalescing surface area for inducing impingement of oil droplets on the medium surface. Each stackable sheet includes a plurality of openings and recesses which are aligned and positioned to form numerous closely-spaced vertical and horizontal communicating passages for maximizing the flow rate of wastewater while simultaneously maximizing the coalescing surface area of the medium.

U.S. Pat. No. 6,730,236, issued on May 4, 2004 to G. E. Kouba, provides a method of separating liquids in a separation system having a flow coalescing apparatus. The flow conditioning apparatus includes an inlet, an outlet, and a swirl chamber extending along a swirl axis. The inlet and outlet cooperate with the swirl chamber to create a swirling of a fluid mixture passing through the swirl chamber to ideally induce coalescence of liquid droplets. The flow of the fluid mixture through the apparatus encounters a minimum of fluid shear and associated droplet dispersion.

U.S. Pat. No. 7,416,657, issued on Aug. 26, 2008 to R. J. Kretchmar, describes an oil/water coalescing separator that is a coalescing chamber containing an oil-coalescing media. The separator is substantially transparent so that the thickness of the band of coalesced oil can be visually discerned at a glance. The separator has a magnet base so the separator can be hung on a machine and off the floor. The separator is also removable from the magnet base.

U.S. Pat. No. 8,985,343, issued on Mar. 24, 2005 to K. S. Mohr, teaches a separator plate used for separating immiscible liquids and solids from a liquid mixture. The oil/water separator plate is composed of bi-directional corrugations extending in both lateral and longitudinal directions, thereby forming a plurality of peaks and valleys. A ramp extends from each peak to the neighboring valleys. An elongated oil port is formed in the peak for passing immiscible liquids that disengage from the liquid mixture. Fences are included along the lower surface of the plate to guide the rising immiscible liquid. The separator plate is configured for stacking by selectively engaging a pin with one of a number of sockets in another plate. The pin and sockets permit varied vertical spacing and alignment in both lateral directions and longitudinal directions.

U.S. Pat. No. 9,289,700, issued Mar. 22, 2016 to Andreussi, provides a coalescence separator for a mixture of immiscible phases with different specific densities. The apparatus includes a tubular body close to the opposite ends and an inlet mouth. There is an outlet mouth of a fluid phase which is defined close to the end of the tubular body at an upper location. Another outlet mouth of the fluid phase is defined close to the end of the tubular body at a lower height. A set of coalescence plates are housed inside the tubular body. Each of the coalescence plates has a flow plate which is tilted at an angle with respect to a plane orthogonal to the longitudinal axis of the tubular body and which has a lower edge facing an end of the tubular body at a lower height and in fluid communication with a distribution channel of the mixture to be separated.

U.S. Pat. No. 11,691,093, issued on Jul. 4, 2023 to Oshinowo et al., provides a coalescing plate having a phyllotaxis-derived pattern. This coalescer plate separates a mixture of immiscible fluids. The coalescer plate includes a pattern of wetting and non-wetting ring regions.

Canadian Patent No. 2 389 065, issued on Jan. 24, 2003 to G. G. Aymong, provides a coalescer apparatus in an oil/water separator. The coalescer includes a frame that supports coalescing plates that are inclined upwardly from the bottom of the frame member. The coalescing plates run parallel to each other that are spaced equally apart. The coalescing plates have a bottom surface that is corrugated and a top surface that is flat without corrugations. Water containing oil and solids is passed through the coalescing apparatus and separation of the oil and solids from the water occurs. The solids fall to the top flat surface of the inclined coalescing plates. The inclined flat surface causes the solids to slide down the plate and out of the coalescer.

Canadian Patent No. 1149756, issued on Jul. 12, 1983 to P. B. Smith, also discloses a coalescer plate for oily water separation. The separator has a plurality of parallel corrugated plates between which the oil/water mixture is constrained to flow. The adjacent plates are separated by spacing and are smoothly shaped to provide substantially laminar flow therealong in a direction generally transverse to the corrugations. A spacing is positioned between a pair of plates at a crest or at a trough in the corrugations.

Korean Patent No. 100230914, issued on Nov. 15, 1999, teaches a separator for water and oil having a dam plate having a plurality of through holes for passing water and oil therethrough. Front and rear flow rate distribution plates have slits elongated in the longitudinal direction at predetermined intervals to distribute the flow rate of the mixed water passing through the through hole of the dam plate. A continuous air ridge and a valet, along with an air chamber, is formed in each ridge so as to define a plurality of water layers. An oil/water separation layer causes the oil floating in the water layers of the air chambers to float to the uppermost surface of the collection tank.

Traditional coalescing plates are limited by fixed spacing configurations. This fixed spacing configuration restricts the ability of such coalescing plates to adapt to varying flow rates, contamination loads and operational environments. Any attempt in the prior art so as to vary the spacing between the coalescing plates requires additional components and complex installation. As such, a need has developed so as to provide variable vertical spacing between the coalescing plates.

It is an object of the present invention to provide coalescing plate pack supports for oil/water separation that reduces material usage.

It is another object of the present invention to provide a coalescing plate packs of providing coalescing plate pack supports for oil/water separation that have enhanced sustainability.

It is another object of the present invention to provide a coalescing plate pack supports for oil/water separation that streamlines the assembly process.

It is another object of the present invention to provide coalescing plate pack supports for oil/water separation that is cost-effective and efficient.

It is still another object of the present invention to provide coalescing plate pack supports for oil/water separation that reduces production time.

These and other objects and advantages of the present invention will become apparent from a reading of the attached specification and appended claims.

### SUMMARY OF THE INVENTION

In one embodiment, the present invention is a coalescing system for supporting immiscible components of different densities mixed in a fluid. This coalescing system includes a vessel having a fluid inlet and a lighter component outlet and a heavier component outlet, a coalescing stack formed of a plurality of vertically spaced-apart coalescing plates positioned within the vessel, at least a pair of bottom supports each having a bottom surface and an undulating upper surface conforming to corrugations in each of the coalescing plates, and at least a pair of top supports having an undulating bottom surface conforming to the corrugations of the coalescing plate. The pair of bottom supports are spaced from each other. Each of the bottom supports has a bottom surface positioned at or adjacent to a bottom of the vessel. The bottom supports support the coalescing stack within the vessel. Each top support of the pair of top supports is spaced from each other. The top supports and the bottom supports have identical configuration that is inverted with respect to each other.

Each of the bottom supports is secured to a lowermost coalescing plate of the coalescing stack. In particular, each of the bottom supports is keyed to the bottom of the coalescing stack and sandwiched with a threaded rod and a nut. The bottom support has an opening having a surface extending around the head of the threaded rod when the threaded rod is secured to the lowermost coalescing plate and to the bottom surface.

The bottom support has a generally M-shaped configuration in which the M-shaped configuration has a pair of apexes at the top surface thereof. The pair of apexes are received within the corrugations of the lowermost coalescing plate of the coalescing stack. A threaded rod stabilizing channel is formed at each of the pair of apexes. A threaded rod received in the threaded rod stabilizing channel. The threaded rod stabilizing channel extends around an exterior of a head of the threaded rod. The generally M-shaped configuration of the bottom support has legs extending upwardly from the bottom surface. The bottom surface is flat and bears against the bottom of the vessel. At least one of the legs of the M-shaped configuration has a triangular-shaped foot at a bottom thereof.

The top support has a W-shaped configuration. This W-shaped configuration has a pair of nadirs at the bottom surface thereof. The pair of nadirs is received within the corrugations of the uppermost coalescing plate of the coalescing stack. A threaded rod stabilizing channel is formed at each of the pair of nadirs. A threaded rod is received in the threaded rod stabilizing channel. The threaded rod joins the uppermost coalescing plate to the top support. The recessed hole extends around an exterior of the head of the threaded rod.

The bottom support has end walls extending in parallel planar relation to each other. Each of the end walls of the bottom support has a channel formed therein. Each bottom support and each top support is formed from an injection mold.

The present invention is also a support article for a coalescing stack in a coalescing system. The support article includes a body having a generally M-shaped or a generally W-shaped configuration. The body is a plurality of legs extending from a bottom surface to a top surface thereof. One of the top surface and the bottom surface is flat while an opposite side is adapted to bear against a coalescing plate of the coalescing stack. This other surface has a receptacle formed therein. The receptacle is adapted to receive a threaded rod that joins the body to the coalescing plate of the coalescing stack. The threaded rod is received in a recess that has a wall extending therearound. The recess is adapted to receive a head of the threaded rod. The wall is adapted to extend around the head of the threaded rod.

Each leg of the body has a triangular-shaped foot. The body has end walls that extend in generally planar parallel relation to each other. Each of the end walls has a channel formed therein. This channel extends vertically.

In particular, the body includes a first body adapted be positioned at a bottom of the coalescing stack and a second body adapted be positioned at a top of the coalescing stack. The first body has a configuration that is identical to the configuration of the second body. Each of the first body and the second body are formed of an injection-molded polymeric material. In particular, each of the first body and the second body is produced from a common mold of an injection molding machine.

This universal coalescing plate pack support provides an innovative redesign aimed at optimizing the traditional support mechanism for coalescing plate pack support legs. In particular, the present invention addresses the inefficiency of using separate top and bottom support pieces by integrating them into a single, interchangeable unit. This universal support of the present invention provides an advanced geometric design so as to meet structural requirements while also reducing material usage and enhancing sustainability. By combining the two commonly used components into one versatile piece, the present invention streamlines the assembly process and offers a significant improvement in both functionality and resource efficiency for coalescing plate pack systems.

The support legs are manufactured using a newly designed tool that is both cost-effective and efficient. Unlike the traditional method of the prior art that requires plastic injection molding with two separate tools and a complex two-axis actuation, the present invention employs a single-direction cavity. As such, this streamlines the manufacturing process and significantly reduces production time and costs.

This foregoing Section is intended to describe, with particularity, the preferred embodiments of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF DRAWINGS

FIG. 1 is a side cross-sectional view showing the coalescing system in accordance with the prior art.

FIG. 2 is an end cross-sectional view of the coalescing system in accordance with the prior art.

FIG. 3 is an upper perspective view showing the support of the present invention.

FIG. 4 is a bottom perspective view showing the support of the present invention.

FIG. 5 is a side elevational view showing the application of the top and bottom supports to a coalescing stack.

FIG. 6 is a side elevational view of a single support of the present invention.

FIG. 7 is a bottom perspective view showing the threaded rod stabilizing channel as used on the support of the present invention.

### DETAILED DESCRIPTION OF THE INVENTION

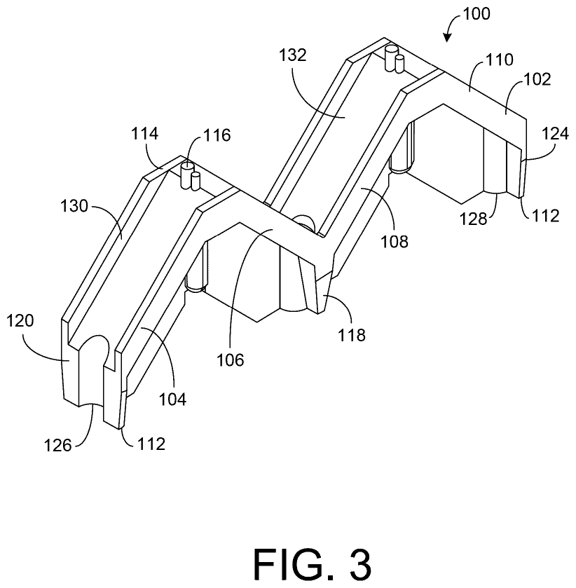

Referring to FIG. 3, there is shown a support 100 in accordance with the preferred embodiment of the present invention. The support 100 can act as both the top support and the bottom support in the coalescing system of the present invention. The support 100 has a body 102 of a generally M-shaped configuration. When used as a top support, the body 102 will have a generally W-shaped configuration. It is important in the present invention that the body 102 is functional both as the top support and the bottom support and can be manufactured in a common mold of an injection molding machine.

The body 102 has a plurality of legs 104, 106, 108 and 110. Legs 104, 106, 108 and 110 extend from the bottom surface 112 toward a top surface 114. The bottom surface 112 is flat so as to bear against the bottom of the vessel of the coalescing system. When used as a bottom support, the top 114 is adapted to engage with a corrugation of a lowermost plate of the coalescing stack. When the body 102 is used as a top support, the bottom surface 112 will naturally be a “top surface”. The top surface 114 will then act as a bottom surface. It will engage with a corrugation of an uppermost coalescing plate of the coalescing stack.

For continued reference, it will be noted that the support 110 is described as the “bottom support”, however, when inverted, it acts as a top support. The referenced bottom surface and top surface will be, respectively, the top surface and the bottom surface.

The top surface 114 has a pass through alignment channel 116 formed therein. The pass through alignment channel 116 is adapted to receive a threaded rod that joins the body 102 to the coalescing plate of the coalescing stack. The pass through alignment channel receptacle is illustrated in greater detail herein, in association with FIG. 7.

FIG. 3 shows that each of the legs 104, 106, 108 and 112 has a triangular foot 118. This triangular foot 118 serves to distribute weight across a large area. The body 102 has end walls 120 and 124 that extend in generally parallel planar relationship to each other. End wall 120 includes a channel 126 formed therein. Similarly, the end wall 124 will include a channel 128 formed therein. Channels 126 and 128 provide for fluid flow from the coalescing stack therealong. These channels 126 and 128 also serve to reduce material used for the formation of the support 100.

FIG. 3 further shows that the body 102 has flanges 130 formed on opposite sides of the central area 132. Flanges 130 provide structural integrity to the support 100 and resist deflection when the coalescing stack is affixed to the top surface 114 thereon.

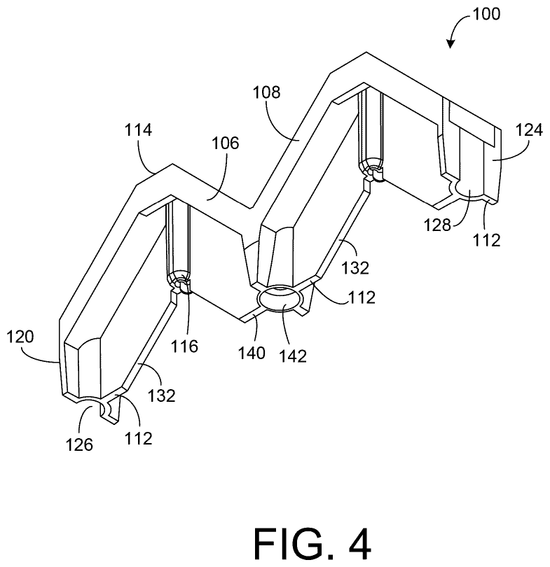

FIG. 4 is a bottom view of the support 100. This bottom view shows the flat bottom surface 112 which will rest against the bottom of the vessel of the coalescing system. A bolster 132 extends from the bottom surface 112 upwardly at an angle. Bolster 132 provides structural integrity to the support 100 while minimizing the amount of material used for the formation of the support. It also serves to reduce the complexity of the injection molded cavity. The alignment channel 116 is formed centrally of the bolster 132 so as to open at the top surface 114. Alignment channel hole 116 is also formed of a polymeric material in a single injection molded process. The positioning of this generally cylindrical alignment channel at the bolster 132 enhances the structural integrity of the support 110.

FIG. 4 further shows the configuration of the channels 126 and 128 at the respective end walls 120 and 124. A cruciform support area 140 is located at the confluence of the legs 106 and 108 along with the bolster 132. As such, this cruciform structure at the area 140 structurally enhances the integrity of the support 110. An orifice 142 is provided at this area 140 so as to allow liquids to drain therethrough.

As stated herein previously, the support 110 can be a top support or a bottom support. The end walls 120 and 124 are adapted so as to bear against the sides of the coalescing vessel. The supports 110 are generally positioned in pairs along the bottom edge of the coalescer pack and along the top of the coalescer pack. As such, the spaced-apart bottom supports will maintain the orientation of the coalescing pack within the vessel. Similarly, the top supports will assure the proper orientation of the coalescing pack.

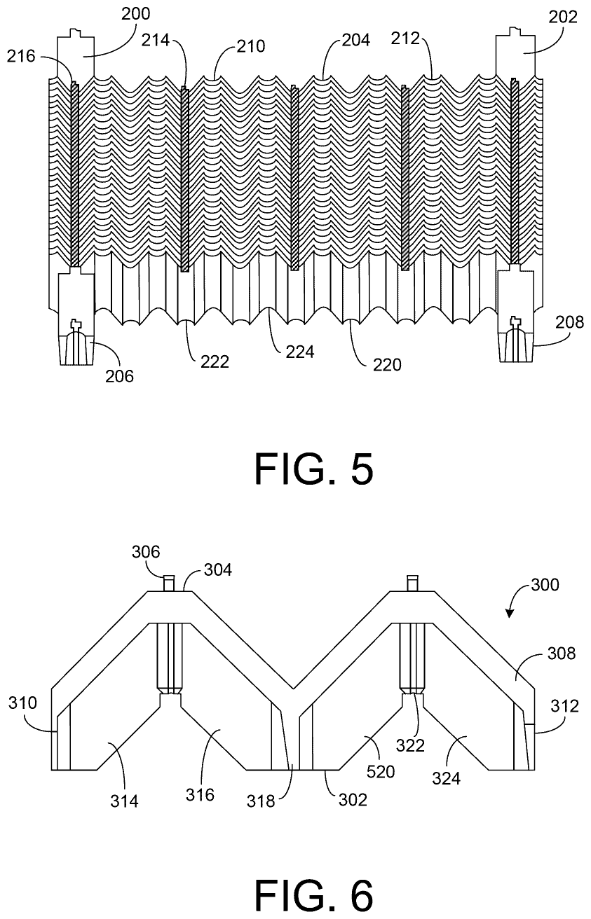

FIG. 5 is a sidecut view that shows, in particular, the configuration of the top supports 200 and 202 as positioned on the coalescer pack 204. The bottom supports 206 and 208 are illustrated as engaged with the coalescer pack 204. It can be seen that the top supports 200 and 202 are arranged in spaced relation to each other. Similarly, the bottom supports 206 and 208 are also arranged in spaced parallel relation to each other.

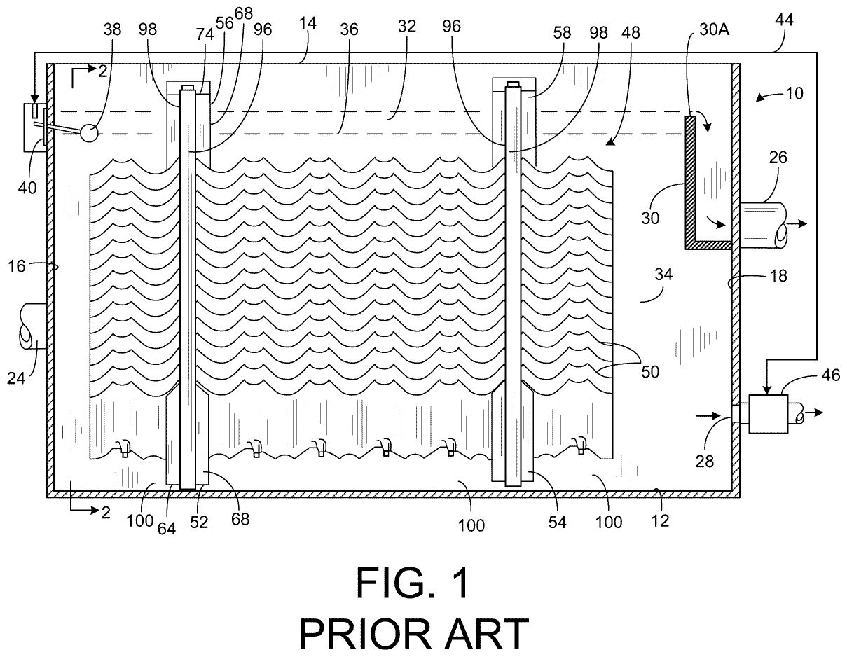

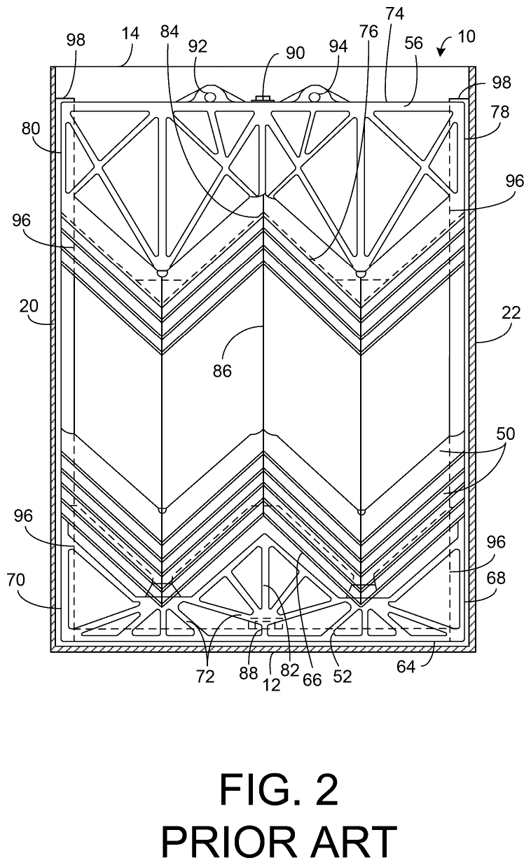

The coalescer pack 204 includes a large plurality of coalescing plates configured in the manner of the prior art (illustrated in FIGS. 1 and 2). It can be seen that the upper coalescing plate 210 has several peaks 212 and valleys 214. It can be seen that the nadir 216 of the top support 200 is received within the valley 214 of the upper coalescing plate 210.

Similarly, the lowermost coalescing plate 220 has peaks 222 and valleys 224. The bottom supports 206 and 208 each has its upper surface received within the respective valleys 224. The peaks and valleys are defined because of the plurality of corrugations formed on each of the coalescing plates of the coalescing stack 204.

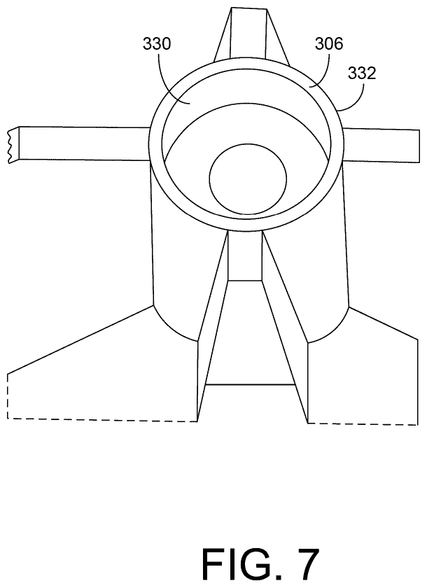

FIG. 6 is a side view showing the bottom support 300. Bottom support 300 includes a flat bottom surface 302 and a generally flat top surface 304. The threaded rod stabilizing channel 306 is formed at the top surface 304. The body 308 of the bottom support 300 includes end walls 310 and 312 that are in spaced parallel relation to each other. Bolster 314 has a paneled shape and extends from the end wall 310 toward the threaded rod stabilizing channel 306. Another panel 316 of the bolster 314 extends from the threaded rod stabilizing channel 306 down to the triangular-shaped foot 318. Another panel 320 extends from the foot 318 upwardly to the other threaded rod stabilizing channel 322. Another panel 324 extends from the threaded rod stabilizing channel 322 toward the end wall 312.

FIG. 7 shows a detailed view of the threaded rod stabilizing channel 306 of both the bottom support and the top support. The threaded rod stabilizing channel is adapted so as to receive a threaded rod that joins the body of the support to the coalescing plate of the coalescing stack. The threaded rod stabilizing channel 306 has a recess 330 with a wall 332 extending therearound. The recess 330 is adapted to receive a head of the threaded rod therein. The wall 322 is adapted to extend around the head of the threaded rod. The threaded rod can actually be inserted into threaded rod stabilizing channel 334 that extends into the body of the support. The recessing of the head of the threaded rod within the recess 330 assures that the damage to the threaded rod is avoided.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

We claim:

1. A coalescing system for separating immiscible components of different densities mixed in a fluid, the coalescing system comprising:
a vessel having a fluid inlet and a lighter component outlet and a heavier component outlet;
a coalescing stack formed of a plurality of vertically spaced-apart coalescing plates positioned within said vessel, each coalescing plate of the plurality of spaced-apart coalescing plates having corrugations defining crests and valleys on each of the coalescing plates;
at least a pair of bottom supports each having a bottom surface, each of said at least a pair of bottom supports having an undulating upper surface conforming to the corrugations of each of the plurality of spaced-apart coalescing plates, the at least a pair of bottom supports being spaced from each other, each of said at least a pair of bottom supports having the bottom surface positioned at or adjacent to a bottom of said vessel, said at least a pair of bottom supports supporting said coalescing stack in said vessel; and
at least a pair of top supports having an undulating bottom surface conforming to the corrugations of the coalescing plate, each top support of said at least a pair of top supports being spaced from each other, each of said at least a pair of bottom supports and each of said at least a pair of top supports having an identical configuration inverted with respect to each other in relation to the coalescing stack.

2. The coalescing system of claim 1, wherein each of said at least a pair of bottom supports is secured to at least one coalescing plate of said plurality of vertically spaced-apart coalescing plates.

3. The coalescing system of claim 2, wherein each of said at least pair of bottom supports is clamped the bottom of said coalescing stack.

4. The coalescing system of claim 3, wherein each of said at least a pair of bottom supports has a threaded rod stabilizing channel having a surface extending around a head of a threaded rod when the threaded rod is secured to the one of the coalescing plates and to the bottom support.

5. The coalescing system of claim 1, wherein a bottom support of said at least a pair of bottom supports has a generally M-shaped configuration in which the M-shaped configuration has a pair of apexes at the top surface thereof, the pair of apexes being received within the corrugations of a lowermost coalescing plate of said coalescing stack.

6. The coalescing system of claim 5, wherein a threaded rod stabilizing channel is formed at each of the pair of apexes, the coalescing system further comprising:
a threaded rod received in the threaded rod stabilizing channel, said threaded rod joining the coalescing plate to the bottom support, the threaded rod stabilizing channel extending around an exterior of a head of the threaded rod.

7. The coalescing system of claim 5, wherein the generally M-shaped configuration of the bottom support has legs extending upwardly from the bottom surface of the coalescing plate, the bottom surface being flat and bearing against the bottom of said vessel.

8. The coalescing plaintiffs claim 7, wherein at least one of the legs of the M-shaped configuration has a triangular-shaped foot at a bottom thereof.

9. The coalescing system of claim 1, wherein a top support of said at least a pair of top supports has a generally W-shaped configuration in which the W-shaped configuration has a pair of nadirs at the bottom surface thereof.

10. The coalescing system of claim 9, wherein a threaded rod stabilizing channel is formed at each of the pair of nadirs, the coalescing system further comprising:
a threaded rod received in the threaded rod stabilizing channel, said threaded rod joining the uppermost coalescing plate to the top support, the threaded rod stabilizing channel extending around an exterior of a head of the threaded rod.

11. The coalescing system of claim 1, wherein each bottom support of said at least a pair of bottom supports has end walls extending in parallel planar relationship to each other, each of the end walls of said bottom support having a channel formed thereon.

12. The coalescing system of claim 1, wherein each bottom support of said at least a pair of bottom supports and each top support of said at least a pair of top supports being formed from a single injection mold.

13. A support article for a coalescing stack in a coalescing system, the support article comprising:
a body having a generally M-shaped or a generally W-shaped configuration, said body having a plurality of legs extending from a bottom surface to a top surface thereof, wherein at least one of the top surface of the bottom surface is flat and adapted to bear against the surface of the coalescing system, another of the top surface and the bottom surface adapted to bear against a coalescing plate of the coalescing stack.

14. The support article of claim 13, wherein the another of the top support and the bottom support has a threaded rod stabilizing channel formed thereon, the threaded rod stabilizing channel adapted to receive a threaded rod that joins the body of the coalescing plate joins the body to the coalescing plate of the coalescing stack.

15. The support article of claim 14, wherein the threaded rod stabilizing channel has a recess with a wall extending therearound, the recess adapted to receive a head of the threaded rod, the wall adapted to extend around the head of the threaded rod.

16. The support article of claim 13, wherein each leg of the plurality of legs has a triangular-shaped foot.

17. The support article of claim 13, wherein said body has end walls that extend in generally parallel planar relation to each other, each of the end walls having a channel formed therein, the channel extending vertically.

18. The support article of claim 13, wherein said body comprises:
a first body adapted to be positioned at a bottom of the coalescing stack; and
a second body adapted to be positioned at a top of the coalescing stack, wherein the first body has a configuration that is identical to a configuration of the second body.

19. The support article of claim 18, wherein each of said first body and said second body are formed of an injection molded polymeric material.

20. The support article of claim 19, wherein each of said first body and said second body is produced from a common mold of an injection molding machine.
